(19) United States
(12) Patent Application Publication
(10) Pub. No.: US 2010/0046410 A1
(43) Pub. Date: Feb. 25, 2010

(54) MCBCS System Initialization and Establishment Over Wireless Broadband Network

(75) Inventors: Tricci So, San Diego, CA (US); Yang Wei Tu, Nanjing (CN); Li Chu, Shenzhen (CN); Jianquan Song, Shenzhen (CN)

Correspondence Address: FISH & RICHARDSON, PC, P.O. BOX 1022, MINNEAPOLIS, MN, 55440-1022, US

(73) Assignee: ZTE (USA) INC., Iselin, NJ (US)

(21) Appl. No.: 12/542,649

(22) Filed: Aug. 17, 2009

Related U.S. Application Data
(60) Provisional application No. 61/089,449, filed on Aug. 15, 2008.
(60) Provisional application No. 61/089,837, filed on Aug. 18, 2008.
(60) Provisional application No. 61/092,671, filed on Aug. 28, 2008.
(60) Provisional application No. 61/092,675, filed on Aug. 28, 2008.

(51) Int. Cl. H04H 20/71; H04W 4/00

(52) U.S. Cl. 370/312; 370/328

(57) ABSTRACT

Systems, apparatuses, and techniques for wireless communications can include receiving an access profile associated with a wireless device from a connectivity service network which is operable to determine whether the wireless device has privilege to a data feed provided by a multicast-broadcast service controller; operating a proxy, which is in communication with the multicast-broadcast service controller, based on the access profile to obtain service parameter information associated with the data feed and to use a first multicast-broadcast service data path between the proxy and the multicast-broadcast service controller to receive the data feed; and operating a base station to deliver the data feed to the wireless device in accordance with the service parameter information, the base station operable to use a second, different multicast-broadcast service data path between the proxy and the base station to receive the data feed.

### CROSS REFERENCE TO RELATED APPLICATIONS

This document claims benefits and priorities of the following prior U.S. patent applications:

1. U.S. Provisional Application Ser. No. 61/089,449, filed Aug. 15, 2008 and entitled “MCBCS System Initialization and Establishment Over Wireless Broadband Network.”

2. U.S. Provisional Application Ser. No. 61/089,837, filed Aug. 18, 2008 and entitled “MBS Synchronous Transmission Support Over WiMAX Access Network.”

3. U.S. Provisional Application Ser. No. 61/092,671, filed Aug. 28, 2008 and entitled “MCBCS System Initialization and Establishment Over Wireless Broadband Network.”

4. U.S. Provisional Application Ser. No. 61/092,675, filed Aug. 28, 2008 and entitled “MBS Synchronous Transmission Support Over WiMAX Access Network.”

The entire contents of all of the above identified documents are incorporated by reference as part of the disclosure of the this document.

### BACKGROUND

This document relates to wireless communication systems.

Wireless communication systems use electromagnetic waves to communicate with fixed and mobile wireless communication devices such as mobile wireless phones and laptop computers with wireless communication cards. Wireless communication systems can include a network of base stations to communicate with wireless devices registered for services in the systems. For example, such systems can include a network of one or more base stations to communicate with one or more wireless devices such as a mobile device, cell phone, wireless air card, a wireless station, user equipment (UE), access terminal (AT), or subscriber station (SS). A wireless device can be referred to as a mobile station (MS) or a mobile node (MN).

A base station (BS) can emit radio signals that carry data such as voice data and other data content to wireless devices. Such a signal from a base station can include information for various communication management functions, including information to allow a wireless device to identify a cell sector of a base station, and to synchronize signaling in time and frequency. A wireless device can processes such information prior to processing of payload data.

A base station and a wireless device can wirelessly communicate using one or more wireless air interface technologies such as orthogonal frequency division multiplexing (OFDM) and orthogonal frequency division multiple access (OFDMA). Some wireless communication systems can operate in accordance with an IEEE 802.16 specification, such as IEEE 802.16e-2005. Some wireless communication systems can operate in accordance with 3GPP2 and 3GPP specifications. Various examples of air interface technologies include wireless interoperability for microwave access (WiMAX), Code Division Multiple Access (CDMA), CDMA2000, High Rate Packet Data (HRPD), and Universal Mobile Telecommunications System (UMTS) technologies.

### SUMMARY

This document describes technologies for wireless communication techniques, apparatuses, and systems.

In one aspect, techniques for wireless communication can include receiving an access profile associated with a wireless device from a connectivity service network which is operable to determine whether the wireless device has privilege to a data feed provided by a multicast-broadcast service controller; operating a proxy, which is in communication with the multicast-broadcast service controller, based on the access profile to obtain service parameter information associated with the data feed and to use a first multicast-broadcast service data path between the proxy and the multicast-broadcast service controller to receive the data feed; and operating a base station to deliver the data feed to the wireless device in accordance with the service parameter information, the base station operable to use a second, different multicast-broadcast service data path between the proxy and the base station to receive the data feed. Other implementations can include corresponding systems, apparatus, and computer programs, configured to perform the actions of the techniques, encoded on computer readable mediums.

These and other implementations can include one or more of the following features. Implementations can include causing an authentication server in the connectivity service network to send the access profile in response to an initial network entry of the wireless device. A wireless device can be associated with the data feed before the initial network entry. A multicast-broadcast service controller can be operable to send a message to an authentication server in the connectivity service network in response to a multicast-broadcast service request from the wireless device. An authentication server can be operable to send the access profile in response to the message from the multicast-broadcast service controller.

These and other implementations can include selectively instantiating the first multicast-broadcast service data path between the proxy and the multicast-broadcast service controller based on whether a prior instantiation of the first multicast-broadcast service data path exists. Implementations can include communicating with a second wireless device that has access to the data feed and can include using the first multicast-broadcast service data path to provide the data feed to the second wireless device.

Implementations can include selectively instantiating the second multicast-broadcast service data path between the proxy and the base station based on whether a prior instantiation of the second multicast-broadcast service data path exists. Implementations can include communicating with a second wireless device that has access to the data feed and can include associating the second wireless device with the second multicast-broadcast service data path. Operating the base station can include operating the base station to deliver the data feed to multiple wireless devices in accordance with the service parameter information.

Implementations can include operating an access service network to provide wireless service to wireless devices based on an orthogonal frequency-division multiplexing air interface. An access service network can include a proxy. Operating the proxy can include operating a multicast-broadcast service distribution function to forward data between the first and second multicast-broadcast service data paths. Access profile can include address information associated with the multicast-broadcast service controller. Service parameter information can include one or more quality-of-service parameters and multicast-broadcast service transmission zone information.

In another aspect, techniques for wireless communication can include operating an anchor access serving network (ASN) to process Multicast Broadcast Service (MCBCS) information obtained from an initial reception of a mobile station's service profile from a respective authentication, authorization and accounting (AAA) server or from a respective policy server to identify one or more serving MCBCS controllers associated with the mobile station; and initializing MCBCS service with an identified MCBCS Controller after an MCBCS Controller service announcement to the mobile station or a mobile station service discovery from the identified MCBCS Controller. Other implementations can include corresponding systems, apparatus, and computer programs, configured to perform the actions of the techniques, encoded on computer readable mediums.

These and other implementations can include operating an anchor Service Flow Authorization (SFA) agent associated with the mobile station to look for a responsible MCBCS Proxy at the anchor ASN to cause triggering of a peer-to-peer service association establishment between the MCBCS Proxy and a corresponding MCBCS Controller when there is no serving MCBCS Controllers for the mobile station.

Apparatuses and systems for wireless communication can include a multicast-broadcast service controller operable to provide a data feed associated with a multicast-broadcast service, a connectivity service network which determines whether wireless devices have a privilege to access the data feed; and an access service network in communication with the connectivity service network and the multicast-broadcast service controller.

An access service network can include a mechanism configured to distribute an access profile associated with a wireless device. Such a mechanism can be operable to receive the access profile from the connectivity service network. An access service network can include a proxy mechanism configured to communicate with the multicast-broadcast service controller based on the access profile. The proxy mechanism can be operable to obtain service parameter information associated with the data feed and to use a first multicast-broadcast service data path between the proxy mechanism and the multicast-broadcast service controller to receive the data feed. An access service network can include a base station operable to deliver the data feed to the wireless device in accordance with the service parameter information. The base station can be operable to use a second, different multicast-broadcast service data path between the proxy mechanism and the base station to receive the data feed.

These and other implementations can include one or more of the following features. A connectivity service network can include an authentication server operable to send the access profile in response to an initial network entry of the wireless device. A wireless device can be associated with the data feed before the initial network entry. A connectivity service network can include an authentication server operable to send the access profile in response to a request message. The multicast-broadcast service controller can be operable to send the request message to the authentication server in response to a multicast-broadcast service request from the wireless device.

An access service network can include a mechanism to selectively instantiate the first multicast-broadcast service data path between the proxy mechanism and the multicast-broadcast service controller based on whether a prior instantiation of the first multicast-broadcast service data path exists. An access service network is operable to communicate with a second wireless device that has access to the data feed and use the first multicast-broadcast service data path to provide the data feed to the second wireless device.

An access service network can include a mechanism to selectively instantiate the second multicast-broadcast service data path between the proxy mechanism and the base station based on whether a prior instantiation of the second multicast-broadcast service data path exists. An access service network can be operable to communicate with a second wireless device that has access to the data feed and to associate the second wireless device with the second multicast-broadcast service data path. The base station can be operable to deliver the data feed to multiple wireless devices in accordance with the service parameter information.

A base station can be configured to provide wireless communications to wireless devices based on an orthogonal frequency-division multiplexing air interface. A proxy mechanism can be operable to use a multicast-broadcast service distribution function to forward data between the first and second multicast-broadcast service data paths. An access profile can include address information associated with the multicast-broadcast service controller. Service parameter information can include one or more quality-of-service parameters and multicast-broadcast service transmission zone information.

The details of one or more implementations are set forth in the accompanying attachments, the drawings, and the description below. Other features will be apparent from the description and drawings, and from the claims.

### BRIEF DESCRIPTION OF THE DRAWINGS

FIG. 1 shows an example of a wireless communication system.

FIG. 2 shows an example of a radio station architecture.

FIG. 3 shows an example of an access service network sharing architecture.

FIG. 4 shows an example of MCBCS broadcast mode operations.

FIG. 5 shows an example of MCBCS multicast mode operations.

FIG. 6 shows another example of a wireless communication system.

FIG. 7 shows an example of a multicast-broadcast service process.

FIG. 8 shows an example of a process that selectively instantiates data paths to provide a multicast-broadcast service.

FIG. 9 shows an example of a multicast-broadcast service initialization procedure based on initial network entry.

FIG. 10 shows an example of a multicast-broadcast service initialization procedure based on initial network entry that uses data path registration.

FIG. 11 shows an example of a multicast-broadcast service initialization procedure via a mobile station service request.

FIG. 12 shows an example of a multicast-broadcast service initialization procedure, via a mobile station service request, that uses data path registration.

FIG. 13 shows a different wireless communication system architecture.

FIG. 14 shows another example of a multicast-broadcast service initialization procedure based on initial network entry.

FIG. 15 shows another example of a multicast-broadcast service initialization procedure via a mobile station service request.

Like reference symbols in the various drawings indicate like elements.

### DETAILED DESCRIPTION

Wireless technology is capable of providing broadband high capacity for various data services, such as voice and data services, and multimedia services (e.g., IPTV or Mobile TV services) over wireless broadband access networks. Multicast Broadcast Services (MCBCS or MBS) via a wireless communication system is a service that is being standardized in various mobile wireless standard bodies such as Third Generation Partnership Project 2 (3GPP2), Open Mobile Alliance (OMA), 3GPP Long Term Evolution (LTE), and Worldwide Interoperability for Microwave Access (WiMAX). A MCBCS can provide rich multimedia content to wireless devices in a wireless communication system.

This document includes examples and implementation details for dynamically initializing multicast-broadcast services and selectively establishing bearer transport within wireless communications systems. Multicast-broadcast services systems can be configured to meet broadband wireless service requirements. Multicast-broadcast services systems implementations for the next generation wireless broadband access networks such as WiMAX or LTE can be designed to reuse existing client software and core network solutions to reduce capital expenditures.

Wireless communication systems can provide one or more multicast-broadcast services using bearer connectivity between one or more Access Service Networks (ASNs) and one or more Connectivity Service Networks (CSNs). In some implementations, wireless communication system can provide multicast-broadcast services in cases where an ASN is shared between multiple wireless service provides. In some implementations, wireless communication system can provide multicast-broadcast services to roaming wireless devices.

The terms “MBS services” and “MCBCS services” are used in the examples provided below as the generic descriptions of different types of multicast and broadcast services. In some implementations, a MBS service can include one or more multicast services, one or more broadcast services, or a combination thereof.

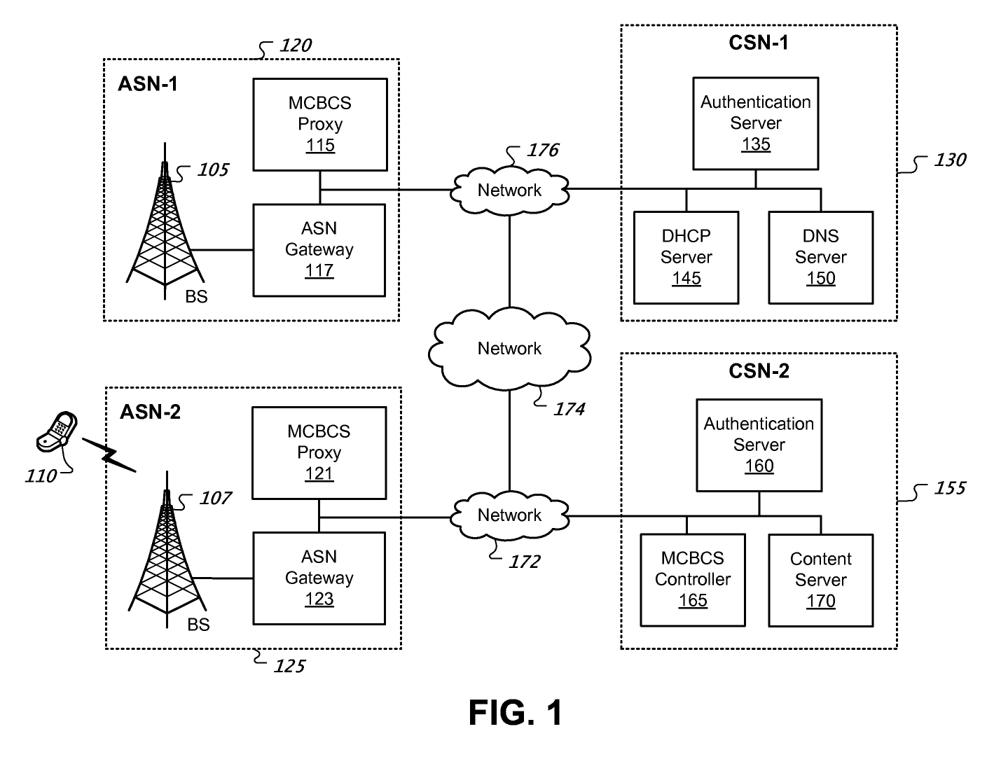

FIG. 1 shows an example of a wireless communication system. The techniques described herein can be implemented in a system such as the one shown in FIG. 1. A wireless communication system can include one or more Access Service Networks (ASNs) 120, 125 and can include one or more Connectivity Service Networks (CSNs) 130, 155. An ASN 120, 125 can include one or more base stations (BSs) 105, 107 to provide wireless services to wireless devices. Some wireless communication systems can refer to a base station as an access point. A base station 105, 107 can transmit a signal on a forward link (FL), called a downlink (DL) signal, to one or more wireless devices 110. A wireless device 110 can transmit a signal on a reverse link (RL), called an uplink (UL) signal, to one or more base stations 105, 107.

A wireless communication system provide one or more MCBCS services to wireless devices. A controller for MCBCS can include a controlling functional component responsible for controlling and managing service via interacting with wireless devices and network entities including a radio access network. A wireless communication system can include one or more MCBCS controllers 165 and one or more content servers 170. A content servers 170 can provide MBS programming content such as multicast content and broadcast content to wireless devices via a MCBCS controller 165. Some systems can include an integrated MCBCS controller 165 and content server 170. In some implementations, different functional aspects of either a MCBCS controller 165 or a content server 170 can reside on one or more different servers. Some system implementations can include one centralized addressable entity responsible for providing and controlling MCBCS to entities such as an ASN or a wireless device.

An ASN 120, 125 can include one or more ASN Gateways (ASN-GWs) 117, 123. In some implementations, an ASN 120, 125 can communicate with a corresponding CSN 130, 155 via one or more networks 172, 174, 176 such as an Internet Protocol (IP) based network. A CSN 130, 155 can include one or more of MCBCS controller 165, content server 170, and an authentication server 135, 160 (e.g., authenticator). In some implementations, an authentication server 135, 160 can include an Authentication, Authorization, Accounting (AAA) server. In some implementations, an authentication server 135 can include a Policy Decision Function (PDF). A CSN 130, 155 can include a Domain Name System (DNS) server 150 to translate between domain names and IP addresses.

In some implementations, a CSN 130, 155 can include a subscriber profile repository configured to store and manage subscriber profiles. An authentication server 135, 160 can control a wireless device's access to network services. In some implementations, an authentication server 135, 160 can access a subscriber profile repository to obtain a device's service policy. In some implementations, a wireless operator can charge for MBS services and can control access to MBS services. In some implementations, an authentication server 135, 160 can perform MCBCS authentication, authorization and accounting.

In some implementations, an ASN 120, 125 can include a mechanism such as an ASN-GW 117, 123 that is configured to perform at least a portion of a wireless device's network entry procedure and to communicate with a CSN 130 to receive an access profile associated with the wireless device from the CSN 130. An access profile can include information to communicate with one or more MCBCS controllers 165, the information can include a domain name or an IP address of a MCBCS controller. The ASN-GW 117, 123 can store access profiles. An ASN-GW 117, 123 can include one or more processing devices to perform functions described herein, the one or more devices can be located in one or more physical locations. An ASN-GW 117, 123 can communicate with one or more MCBCS proxies 115, 121. MCBCS proxies 115, 121 can establish data paths with one or more one or more MCBCS controllers 165. In some implementations, an ASN-GW 117, 123 can include one or more MCBCS proxies 115, 121. An ASN-GW 117, 123 can include one or more authentication servers.

A wireless device 110 can have a home ASN and a home CSN such as ASN-1 120 and CSN-1 130 respectively. The wireless device 110 can move to a geographical area served by a different ASN and CSN, which are known by the context of the wireless device 110 as a visiting ASN (V-ASN) and a visiting CSN (V-CSN) such as ASN-2 120 and CSN-2 155 respectively.

A wireless communication system can use one or more Dynamic Host Configuration Protocol (DHCP) techniques to provide configuration information to a wireless device. DHCP techniques can be used to configure an IP address for a client device and can provide system parameters. In some implementations, a DHCP technique can assign an IP address to a wireless device such that the wireless device can send and receive IP data packets. In some implementations, a DHCP technique can provide system information to a wireless device. System information can include address information for one or more servers.

In some implementations, address information provided by a DHCP entity can include an IP address such as an IP version 4 (IPv4) address or an IP version 6 (IPv6) address. In some implementations, address information can include a fully qualified domain name (FQDN). A DHCP servers such as a DHCPv4 server or a DHCPv6 server can provide address information in IPv4 or IPv6 networking environments respectively. In some implementations, a device can communicate with a DNS server 150 to resolve a FQDN into an IP address that a device can use to communicate with a device associated with the FQDN.

To facilitate communications with a DHCP server, an ASN 120, 125 can include a DHCP node. In some implementations, a DHCP node in an ASN can act as a DHCP server for a wireless device that is visiting the ASN. In some implementations, a DHCP node of an ASN can provide connectivity between a visiting wireless device and a home DHCP server. For example, a DHCP node can send and receives DHCP messages with a home DHCP server to provide information to a visiting wireless device.

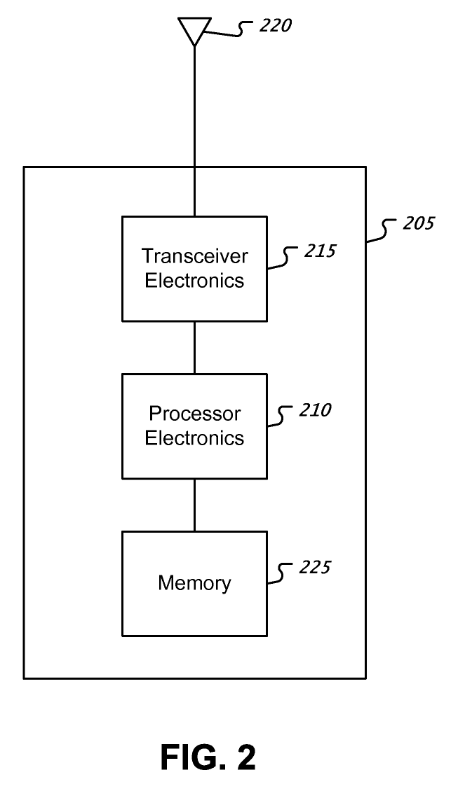

FIG. 2 shows an example of a radio station architecture. Various examples of radio stations include base stations and wireless devices. A radio station 205 such as a base station or a wireless device can include processor electronics 210 such as a microprocessor that implements methods such as one or more of the techniques presented in this document. A radio station 205 can include transceiver electronics 215 to send and/or receive wireless signals over one or more communication interfaces such as one or more antennas 220. A radio station 205 can include other communication interfaces for transmitting and receiving data. In some implementations, a radio station 205 can include one or more wired communication interfaces to communicate with a wired network. A radio station 205 can include one or more memories 225 configured to store information such as data and/or instructions. In some implementations, processor electronics 210 can include at least a portion of transceiver electronics 215 and a memory 225.

Radio stations 205 can communicate with each other based on an orthogonal frequency-division multiplexing (OFDM) air interface which can include Orthogonal Frequency-Division Multiple Access (OFDMA) air interface. In some implementations, radio stations 205 can communicate using one or more wireless technologies such as Worldwide Interoperability for Microwave Access (WiMAX), Long-Term Evolution (LTE), Code division Multiple Access (CDMA) such as CDMA2000 1x, High Rate Packet Data (HRPD), and Universal Mobile Telecommunications System (UMTS).

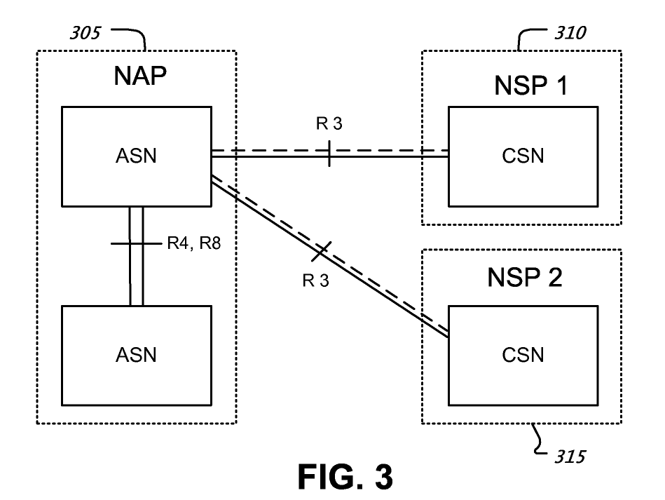

FIG. 3 shows an example of an access service network sharing architecture. Various wireless broadband access business models can include a Network Access Provider (NAP) and a Network Service Provider (NSP). A NAP 305 is a type of wireless operator that is responsible for managing and controlling one or more ASNs. A NSP 310, 315 is a different type of wireless operator that is responsible for managing and controlling one or more CSNs. Various ASN sharing architectures can include a NAP 305 that organizes multiple parallel business and service offering arrangements with different NSPs 310, 315 to provide multi-access for wireless subscribers of multiple NSPs 310, 315 that use the same ASN resource pools such as the ASNs provided by the NAP 305. FIG. 3 includes an example of ASN sharing via a WiMAX Network Reference Model (NRM). In some implementations, a single business concern such as a single wireless operator can own and manage both NAP 305 and NSP 310, 315 assets.

Implementations of various techniques described in this document can be configured for ASN-aware MCBCS services. For example, there can be business partnership and service offering coordination between a NAP and a NSP to provide multicast-broadcast services for wireless devices. An ASN can maintain a Service Level Agreement (SLA) associated with one or more MCBCS services in the delivery of MCBCS content to wireless devices. An ASN can use one or more MCBCS operations modes to delivery content. Various examples of MCBCS operation modes can include broadcast, static multicast, and dynamic multicast.

In some implementations, pre-provisioned MBS services are arranged before network attachment by a MS. For example, a MS can have one or more existing service subscriptions with a serving NSP before attaching to a wireless network. In some implementations, dynamic services are arranged after network attachment. For example, a MS can subscribe to a MCBCS program with a serving NSP after the MS attaches to a wireless network.

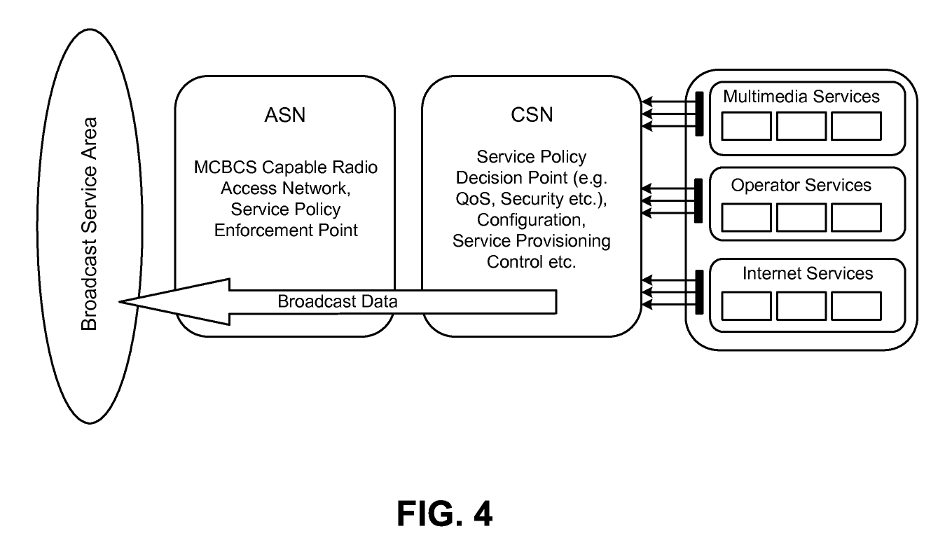

FIG. 4 shows an example of MCBCS broadcast mode operations. A broadcast mode can use a unidirectional point-to-multipoint type of transmission of multimedia data from a single source to one or more wireless devices residing in a broadcast service area such as a MCBCS transmission zone. The broadcast mode can use one or more common radio channels for the downlink transmission of broadcast data. A bit rate associated with a broadcast mode transmission can be varied to adjust radio resource allocation. In some implementations, a wireless device can acquire a broadcast access key (BAK) to receive a MCBCS downlink transmission.

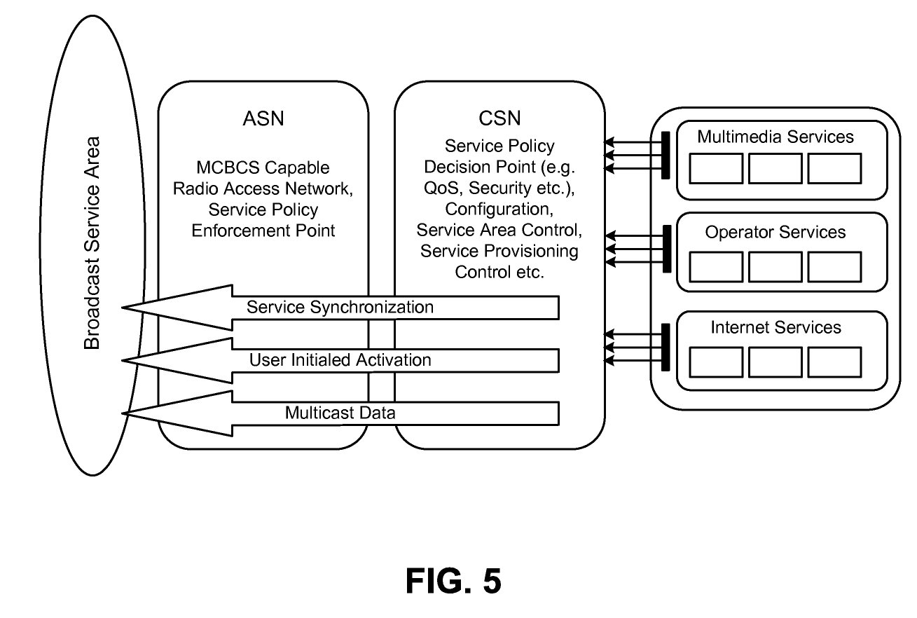

FIG. 5 shows an example of MCBCS multicast mode operations. In some implementations, a base station can multicast data to a specific group of wireless devices. A wireless device can request a multicast service. In some implementations, a user of a wireless device can subscribe to a multicast service. A wireless operator can charge a service fee to access multicast content. A wireless operator can add or remove wireless devices from a multicast service. A multicast mode can include operating an ASN to selectively control a wireless device to receive downlink MCBCS traffic within a multicast service area that contains members of a multicast group. In some implementations, a wireless device can acquire a multicast access key (MAK) to receive a MCBCS downlink transmission.

In some implementations, a multicast mode can include a static multicast mode. In some implementations, a multicast mode can include a dynamic multicast mode. For static multicast, a MBS distribution tree data path can be pre-established between an ASN and a CSN and can be pre-established in a wireless access network covering a multicast service area. For dynamic multicast, a multicast distribution tree data path can be dynamically established on a per-MS and per-service basis in a network and in a wireless access network serving a multicast service area. In some implementations, a multicast distribution tree establishment across one or more service areas can be pre-configured or can be triggered by an event within an ASN or a CSN. In some implementations, multicast distribution tree establishment can be triggered by a per-MS and per-service basis within the service areas.

In some implementations, an anchor ASN can host MCBCS related functions to control the MCBCS operation over a service area for a one or more MCBCS related transmissions. A MS can receive the downlink MCBCS related transmissions from a serving ASN. In some cases, the anchor ASN can be the serving ASN for a MS if the MS is receiving the downlink transmission from the anchor ASN.

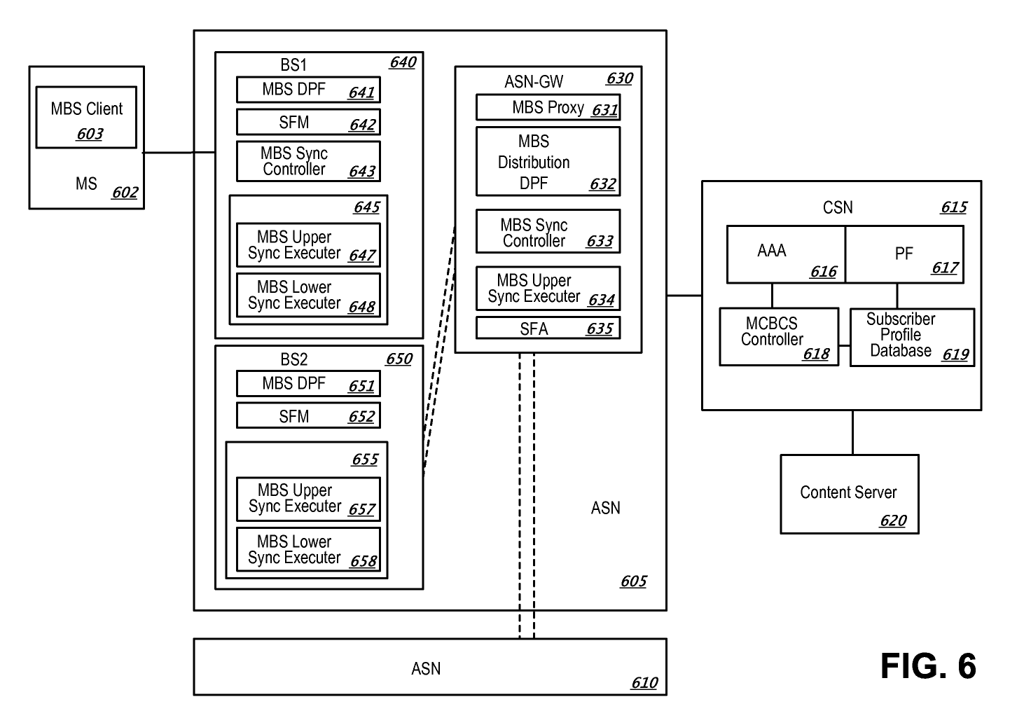

FIG. 6 shows another example of a wireless communication system. A wireless communication system can include one or more CSNs 615 and one or more ASNs 605 610 to provide wireless services to wireless devices. A wireless communication system can communicate with one or more content servers 620 to provide content to wireless devices. In some implementations, a content server 620 such as a MCBCS content server can provide content for one or more services such as multimedia flows and data files to a wireless communication system. In some implementations, a NSP can provide content and can operate a content server 620 that communicates with a CSN 615 to provide content. In some implementations, a commercial broadcast network server can include a content server 620 that communicates with a CSN 615.

Some CSNs 615 can include a MCBCS controller 618, which can be implemented by one or more processors. A MCBCS controller 618 can host one or more MCBCS specific functional components in the CSN 615. Service association between an ASN 605 and a CSN 615 can be statically configured. In some implementations, service association between an ASN 605 and a CSN 615 can be dynamically established based on an event trigger, within the ASN or CSN, such an MS network entry or a MBS service request. In some implementations, a service association is a binding between two or more network entities.

In some implementations, a MCBCS controller 618 can perform IP multicast group management, MCBCS program management, MCBCS service announcement management such as MCBCS programming guide manipulation and distribution, MCBCS session management, and delivery of the mapping information such as a mapping between a MCBCS content IP address and a multicast connection identifier (MCID). A MCBCS controller 618 can provide security functions such as MCBCS data encryption support, application layer key management, and security association support for an application layer.

A CSN 615 can include one or more of an AAA 616 and a Policy Function (PF) 617 to perform MCBCS authentications, authorizations, and accounting functions. An AAA 616 and a PF 617 can control a wireless device's access to network services and can have access to a subscriber profile database 619 to obtain an access profile, e.g., subscriber's service policy information, associated with a wireless device. In some implementations, one or more of an AAA 616 and a PF 617 can provide mobile station access authorization for the access of one or more MCBCS services over a corresponding WiMAX access network. In some implementations, a wireless communication system can include an AAA 616 and a PF 617 at one or more physical locations. In some implementations, a MS WiMAX access authorization can be used to authorize access to the MCBCS services supported by an AAA server. In some implementations, interacting with a PF can include using FFS for MCBCS.

A subscriber profile database 619 can store and manage subscriber profiles. The subscriber profile database 619 can store information relating to unicast services for mobile stations. The subscriber profile database 619 can interface with one or more of an AAA server 616 or a PF 617.

An ASN 605, 610 can interface with one or more CSNs 615 to provide MCBCS. In some implementations, an ASN 605 can include ASN-GW 630 to control one or more base stations, e.g., BS1 640 and BS2 650, which provide wireless servies to one or more mobile stations. A mobile station 602 can include a MBS client 603 configured to request and process a MCBCS data feed.

An ASN-GW 630 can include a MBS Proxy 631 to support MCBCS. In some implementations, a MBS Proxy 631 is a control plane function for a whole MBS zone. In some implementations, the span of control of the MBS Proxy 631 can be spread across one or more MBS zones for a specific MCBCS. A MBS Proxy 631 can interact with the ASN and CSN MCBCS functions to support MCBCS network session management. In some implementations, a MBS Proxy 631 can assign the MCBCS access parameters such as MCID's, MBS Zone ID's, etc. for a given MBS Zone. A MBS Proxy 631 can perform MBS service policy enforcement for multicast transport to enable the MCBCS service over a wireless communication system. Various examples of policy enforcement can include Quality-of-Service (QoS), accounting, and MCBCS Transmission Zone to MBS Zone mappings. A MBS Proxy 631 can interface with a one or more data path functions (DPFs) such as a MBS Distribution DPF 632 to trigger MBS data path establishment, maintenance, and release within a MBS zone. In some implementations, a MBS Proxy 631 is collocated or integrated with a MBS Distribution DPF 632 in an ASN-GW 630.

Some ASNs can perform Service Flow Authorization (SFA) on one or more of unicast service flows, multicast service flows, and broadcast service flows to control access. In some implementations, an ASN 605 can include a SFA function 635 to manage MCBCS service requests for one or more mobile stations according to respective access profiles. A SFA function 635 can obtain an access profile from an AAA 617. A SFA function 635 can assign a service flow ID for a specific MCBCS service flow for a MS based on a successful authorization of the MS to access a MBS service. A SFA function 635 can receive an authorization result from an entity such as an AAA server 616 or PF 617. A SFA function 635 can interact with a MBS Proxy 631 to provide MCBCS service flow establishment, modification, and release.

A MBS Distribution DPF 632 can provide MBS bearer control management and data distribution for one or more MBS Zones associated with an ASN 605. In some implementations, a MBS Distribution DPF 632 is a bearer plane entity in a NAP, which can be located in an ASN-GW 630. A MBS Distribution DPF 632 can perform MBS bearer control management such as data path (DP) establishment, maintenance, and release. A MBS Distribution DPF 632 can perform MBS bearer traffic classification and data distribution, can perform Generic Routing Encapsulation (GRE) key and sequencing number management and distribution, and can provide one or more MCBCS accounting agent functions for MCBCS accounting support.

In some implementations, a primary MBS Distribution DPF corresponds to a MBS zone. A MBS Distribution DPF can perform operations associated with an Internet Group Management Protocol (IGMP) client such as sending IGMP report messages to a multicast router between an ASN and a CSN to join an IP multicast group tree.

A MBS Distribution DPF 632 can forward MBS data feed packets received over an R3 interface from a MCBCS controller 618 to the MBS data sync functions to support downlink frame level coordination or macro diversity. In some implementations, a MBS Distribution DPF 632 can interact with a MBS sync function to support downlink frame offset synchronization for between MBS Zones, and frame level synchronization or macro diversity within a MBS Zone. A MBS Distribution DPF 632 can manage one or more zones including zone synchronization.

A Serving MBS Distribution DPF can forward IP multicast packets received from a primary MBS Distribution DPF if unicast transport multicast distribution tree is used. In some implementations, a distribution DPF can act as a Secondary Distribution MBS DPF in a MBS zone to receive data from Primary MBS Distribution DPF and further deliver content in a MBS zone if synchronization between zones is supported. A MBS Distribution DPF can distribute a data feed to a MBS DPF in a BS.A base station 640, 650 can include a MBS DPF 641, 651. A MBS DPF 641, 651 can include one or more MBS bearer control management functions of an ASN 605.

A base station 640, 650 can include a service flow management (SFM) entity 642, 652. A SFM entity 642, 652 can manage one or more of unicast services flows, multicast services flows, and broadcast services flows. A SFM entity 642, 652 can create, modify, or delete of service flow for a given IP mutlicast address and the associated airlink service parameters assignment for a MS and can use the IEEE 802.16Rev2 based DSx airlink signaling.

A MBS sync function can coordinate MCBCS content downlink transmission over a single frequency or multi-frequency WiMAX networks in one or more MBS zones. Base stations 640, 650 and ASN-GW 630 can include one or more MBS sync functions such as a MBS Sync Controller 633, 643 and MBS Sync Executers 634, 645, 655.

A MBS Sync Controller 633 can interact with a MBS Distribution DPF 632 to provide synchronization rules, including timestamp to support downlink frame level coordination or macro diversity. A MBS Sync Controller 633 can delivers MBS synchronization rules including time stamp to a MBS Sync Executer 634, 645, 655. A MBS Sync Controller can support one or more MBS Zones.

A MBS Sync Executer 645, 655 can execute MBS synchronization rules given by a MBS Sync Controller 643, 633 to perform data synchronization. A MBS Sync Executer 645, 655 can include a MBS Upper Sync Executer 647, 657 configured to construct Media Access Control (MAC) Packet Data Units (PDUs) and package MAC PDUs into a MAC burst based on one or more synchronization rules. A MBS Sync Executer 645, 655 can include a MBS Lower Sync Executer 648, 658 configured to construct a final layer (PHY) burst which can correspond to a MCID(s) in a given MBS permutation zone corresponding to a MBS Zone based on one or more synchronization rules. A MBS Lower Sync Executer 648, 658 can communicate mapping information between MCIDs and corresponding MBS zone identifiers. In some implementations, a MBS Lower Sync Executer 648, 658 can broadcast a MBS_MAP_IE, MBS_MAP and MBS_DATA_IE including the MBS zone ID and MCID.

On a mobile station 602, a MBS client 603 can interact with a MBS service. In some implementations, a MBS client 603 can include an IP multicast capable IPv4 stack. In some implementations, a MBS client 603 can include an IP multicast capable IPv6 stack. A MBS client 603 can perform one or more of service discovery, service announcement, service subscription, service registration, application layer security, statistic collection support, and MCBCS program content reconstruction.

A wireless communication system can provide MBS services to mobile stations. A wireless communication system can use access profiles such as MS service profiles to manage MBS service for respective mobile stations. The wireless communication system can include a service initialization mechanism that is triggered by one or more events such as MS network entry, post-entry service subscription, and post-entry service registration. The service initialization mechanism can operate an authentication server, such as an AAA server or policy server in a CSN, to deliver service profiles to one or more ASNs, which can control multicast or broadcast downlink airlink transmissions.

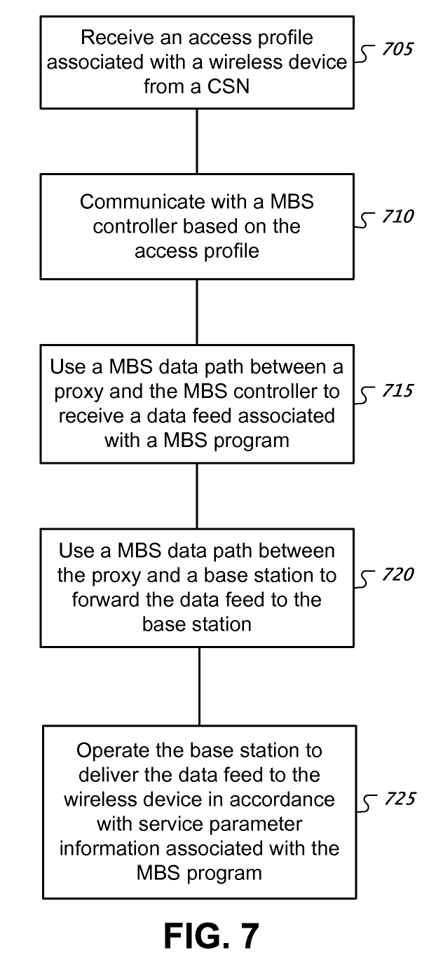

FIG. 7 shows an example of a multicast-broadcast service process. An ASN can receive an access profile associated with a wireless device from a CSN (705). The ASN can communicate with a MBS controller based on the access profile (710). The ASN can use a MBS data path between a proxy and the MBS controller to receive a data feed associated with a MBS program (715). The ASN can use a MBS data path between the proxy and a base station to forward the data feed to the base station (720). The ASN cam operate the base station to deliver the data feed to the wireless device in accordance with service parameter information associated with the MBS program (725).

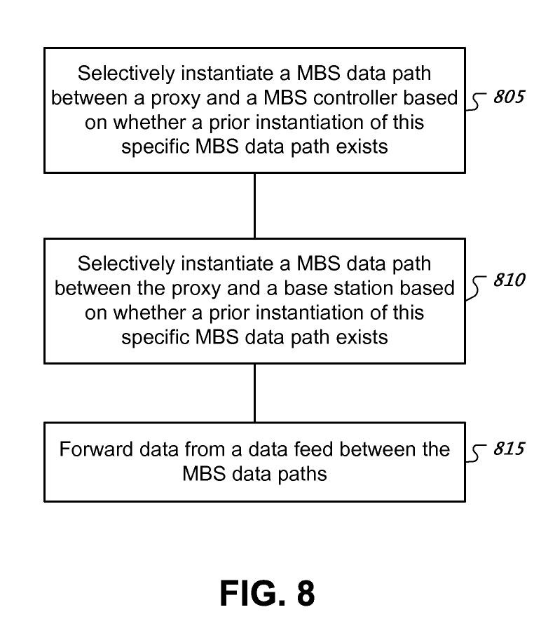

FIG. 8 shows an example of a process that selectively instantiates data paths to provide a multicast-broadcast service. A wireless communication system process can selectively instantiate a multicast-broadcast service data path between a proxy and a multicast-broadcast service controller based on whether a prior instantiation of this specific multicast-broadcast service data path exists (805). When such a multicast-broadcast service data path already exists, the process can associated a wireless device with the data path. The process can selectively instantiate a multicast-broadcast service data path between the proxy and a base station based on whether a prior instantiation of this specific multicast-broadcast service data path exists (810). When such a multicast-broadcast service data path already exists, the process can associated a wireless device with the data path. The process can operate one or more network entities to forward data from a data feed associated with a MBS service between multiple multicast-broadcast service data paths (815).

Some wireless communication systems can provide services that are pre-provisioned for one or more mobile stations. In some implementations, a CSN can authenticate and authorize a MS to receive MBS services. In some implementations, an ASN can authenticate and authorize a MS to access MBS services via a CSN. A CSN can deliver an access profile, e.g., MS service profile, of a successfully authenticated and authorized MS to an ASN.

For a corresponding MS, a MS service profile can indicate one or more privileges related to accessing one or more services provided by a MCBCS controller. A MS service profile can include address information associated with one or more MCBCS controllers. In some implementations, address information can include an IP address of a MCBCS controller. In some implementations, address information can include a FQDN of a MCBCS controller. In some implementations, a MS service profile can include one or more MBS service parameters corresponding to one or more pre-provisioned MBS services. Various MBS service parameters can include MCBCS controller address information, QoS parameters, IP multicast address, MBS programming channel, charging, and accounting policy.

Some wireless communication systems can include a mechanism to handle dynamic service requests. For example, a MS can request a MBS service after network entity. Various examples service requests can include a MBS subscription request and a MBS registration request. In some implementations, a MS can initiate a MCBCS service subscription or registration with a MCBCS controller. A MS can obtain address information for a specific MCBCS controller to address a service request. The MS can use the address information to send a service request to a MCBCS controller associated with a desired data feed.

A MCBCS controller can communicate with an authentication server based on network attachment information (NAI) associated with the MS to validate the MS's access authorization with an associated ASN. An authentication server can send a MS service profile to an ASN. MCBCS system service initialization can include operating a serving ASN to receive a MS service profile. A serving ASN can establish a service association with a corresponding MCBCS controller and can instantiate bearer infrastructure to deliver MBS programming to a MS. A serving ASN can communicate with one or more MCBCS controllers to deliver one or more services to a MS. In some implementations, a MCBCS controller can provide one or more MBS services to mobile stations. In some implementations, a MCBCS controller can communicate with one or more MCBCS proxies to provide one or more MBS services.

A serving NSP and a serving NAP can use a MCBCS service establishment process to establish MBS service infrastructure. In some implementations, a service establishment process can include establishing ASN multicast or broadcast bearer infrastructure and establishing an airlink multicast connection.

An anchor ASN can control downlink airlink transmission, e.g., a multicast or a broadcast transmission, for one or more devices. A wireless communication system can establish a peer-to-peer service association between a MCBCS proxy at an anchor ASN and a corresponding MCBCS controller associated with a MBS data feed. In some implementations, peer-to-peer service association can include a binding operation.

In some implementations, a wireless communication system can use information associated with an established peer-to-peer service association between a MCBCS proxy and a MCBCS controller to provide additional services. For example, an ASN can leverage the addressing information of a controller obtained during a previous controller discovery process to provide additional services. In some implementations, a service association can be statically configured and a MS can perform a dynamic controller discovery.

A wireless communication system can establish ASN multicast or broadcast service infrastructure. In some implementations, an ASN can receive service parameters associated with a MCBCS program from a controller. In some implementations, an ASN can statically or dynamically establish network infrastructure based on one or more service parameters.

Service establishment can include establishing an airlink multicast connection to deliver a data feed to one or more mobile stations. Initial network entry by a MS associated with one or more pre-provisioned services can trigger airlink multicast connection establishment. A MS can request a new service after network entry. In some implementations, a MBS service request after network entry can trigger airlink multicast connection establishment.

Dynamic data path establishment can include operating a serving ASN to connect with one or more base stations associated with a MCBCS service area. A MCBCS service area can include one or more MBS zones. Dynamic data path establishment can include using one or more service parameters associated with a MCBCS program. Various service parameters can include a MCBCS service policy, QoS parameters, service area identifier, and a multicast address. In some implementations, an authentication server such as an AAA server or policy server can send a service parameters associated with a program to a serving ASN. MCBCS service parameters can be propagated by a proxy via a MS's anchor SFA. A proxy can trigger a MCBCS data path establishment with one or more base stations associated with a MCBCS service area.

An ASN can leverage an existing peer-to-peer service association between a MCBCS proxy and a MCBCS controller to provide services to mobile stations. In some implementations, an ASN can receive multiple MS service profiles associated with an existing proxy and controller peer-to-peer service association, and can associate additional devices with an existing peer-to-peer service association in lieu of forming an additional connection between the same set of peers.

In some implementations, a peer-to-peer service association between a proxy and a controller can be released when the last MS associated with the peer-to-peer service association signs off from the anchor ASN for a MBS service. In some implementations, a proxy can maintain a counter for registered mobile stations for a specific MBS service.

An ASN can use MCBCS information obtained from a previous retrieval of a MS service profile from an authentication server that is operable to identify one or more MCBCS controllers that can serve the MS. In some cases, a MCBCS service association may not have been established between a proxy and a corresponding controller before an ASN receives a MS service profile from an authentication server.

An anchor SFA associated with the MS can select a proxy based on a MS service profile. In some implementations, an anchor SFA can trigger a peer-to-peer service association establishment between a selected proxy and a corresponding controller in response to receiving MS service profile information. In some implementations, an anchor SFA can determine whether a service association already exists by accessing an ASN database that tracks service and security associations between the proxies and controllers.

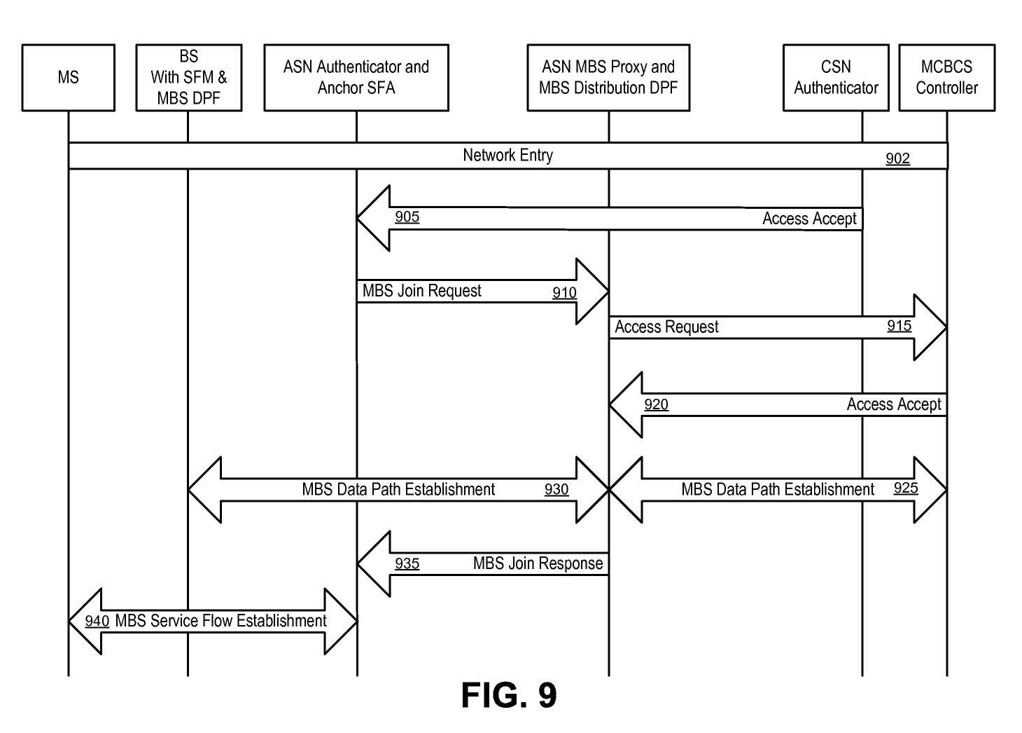

FIG. 9 shows an example of a multicast-broadcast service initialization procedure based on initial network entry. Network entry of a mobile station on to a wireless network can include interfacing between multiple network entities (902). MS network entry can trigger one or more pre-provisioned service initialization procedures. In response to a MS network entry, a CSN authenticator such as a home AAA (H-AAA) can send an access accept message to an authenticator located in an ASN-GW (905). An access accept message can include an access profile, which can include multicast-broadcast service related parameters. Various examples of multicast-broadcast service related parameters can include MS identifier, IP address of a MCBCS Controller, and FQDN of a MCBCS Controller. In some implementations, an ASN authenticator can forward access accept messages from an AAA server to an anchor SFA.

In some implementations, an anchor SFA can determine an address of a MBS proxy to provide a multicast-broadcast service to a MS based on information received from an authenticator. In some implementations, an anchor SFA can select an appropriate MCBCS proxy corresponding to a MCBCS Controller identified by a MS access profile. The anchor SFA can send a MBS join request to the MCBCS proxy (910).

In some implementations, an ASN can include one or more of AAA, Anchor SFA, and MBS proxy. In some implementations, an anchor SFA can determine whether a MCBCS proxy and MCBCS Controller service association exists by accessing ASN configuration information.

Based on a join request from the anchor SFA, the MCBCS proxy can send an access request to a MCBCS Controller (915). Once the service association is established between the MCBCS proxy and the MCBCS Controller, the MCBCS Controller can respond with an access accept, which can include service parameters associated with a MCBCS program, to the MCBCS proxy (920). Service parameters can include one or more of MCBCS transmission zone, IP multicast address for a MCBCS service distribution tree, program identifier, QoS parameters, and accounting type.

An anchor ASN can receive a service parameters associated with a MCBCS program from a MCBCS Controller. A MCBCS proxy can use the service parameters to trigger a service infrastructure establishment of one or more multicast-broadcast service data paths. In some implementations, service infrastructure establishment can include establishing a multicast-broadcast service data path between a MCBCS Controller and a MBS proxy (925). Service infrastructure establishment can include establishing a multicast-broadcast service data path between a MBS proxy and a MBS DPF in a base station (930). In some implementations, a MBS Proxy can send a join response to the Anchor SFA to notify the Anchor SFA about the establishment of the multicast-broadcast service data path (935). The anchor SFA and MS can establish a MBS service flow (940).

In some implementations, service infrastructure establishment can include establishing a local ASN MCBCS service control and content distribution tree based on a coverage area of a MBS zone or a transmission zone associated with the MCBCS program. A MCBCS Proxy can map a MCBCS transmission zone into one or more MBS Zones associated with the anchor ASN. In some implementations, a MCBCS Proxy can use an ASN local configuration policy to performing the mapping. In some implementations, a MCBCS Proxy can use a service policy between the NAP and the serving NSP.

In some implementations, a MCBCS Proxy can control multiple MBS Zones to provide service continuity across the multiple MBS Zones with frame-level synchronization support. In some implementations, a MCBCS Proxy can select one or more different MCBCS proxies to manage and control additional MBS Zones for specific MCBCS transmissions. Consequently, affected BSs that correspond the given MBS Zone(s) are also identified and the multicast distribution tree can be established accordingly. If an additional MCBCS Proxy is selected for other MBS Zone(s), it can be served by a different MBS DPF. A MCBCS Proxy can trigger a corresponding DPF to establish a R3-binding with the multicast content distribution at the serving CSN. A MCBCS Proxy can trigger the corresponding DPF to establish the content distribution tree to one or more BSs that correspond to the same MBS Zone or the same MCBCS Transmission Zone at the local ASN over R6 and/or R4.

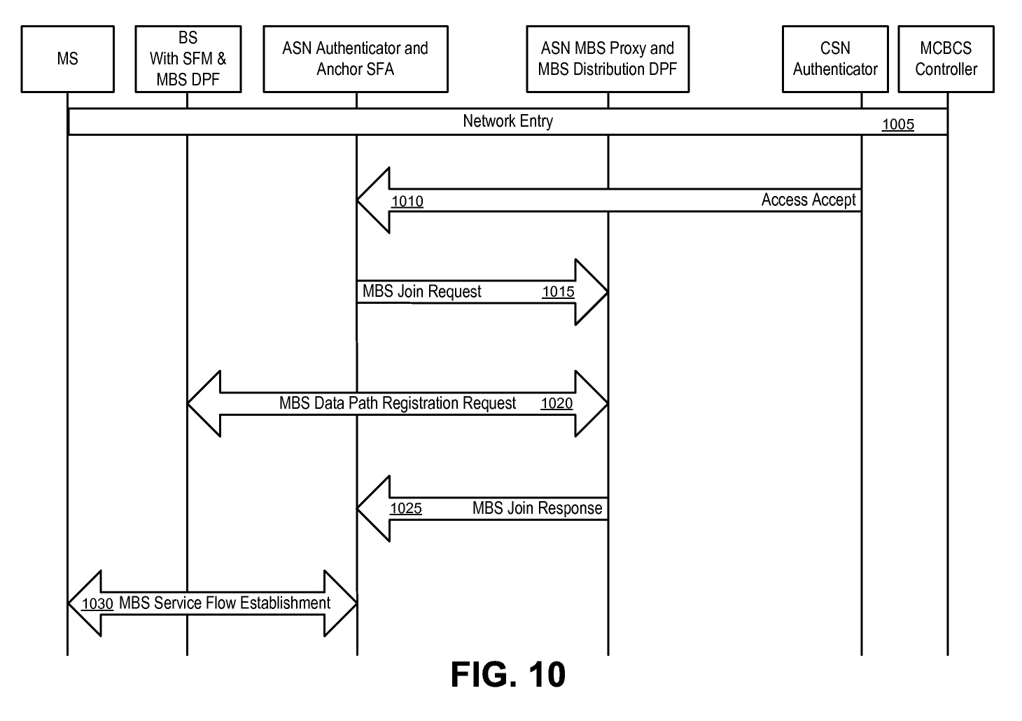

FIG. 10 shows an example of a multicast-broadcast service initialization procedure based on initial network entry that uses data path registration. In this example, bearer infrastructure for a MBS service already exists. Network entry of a mobile station on to a wireless network can include interfacing between multiple network entities (1005). An ASN authenticator such as a serving AAA can receive an access accept message from a CSN authenticator such as a home AAA (1010). The serving AAA can communicate with an Anchor SFA. The Anchor SFA can select a MBS proxy and can send a MBS join request to the selected MBS proxy (1015). The MBS proxy can communicate with a MBS DPF in a BS serving the MS. In some implementations, the MBS proxy can perform MBS data path registration with a MBS DPF (1020). The MBS proxy can send a MBS join response to the Anchor SFA to signal a successful data path registration (1025). The anchor SFA and MS can establish a MBS service flow (1030).

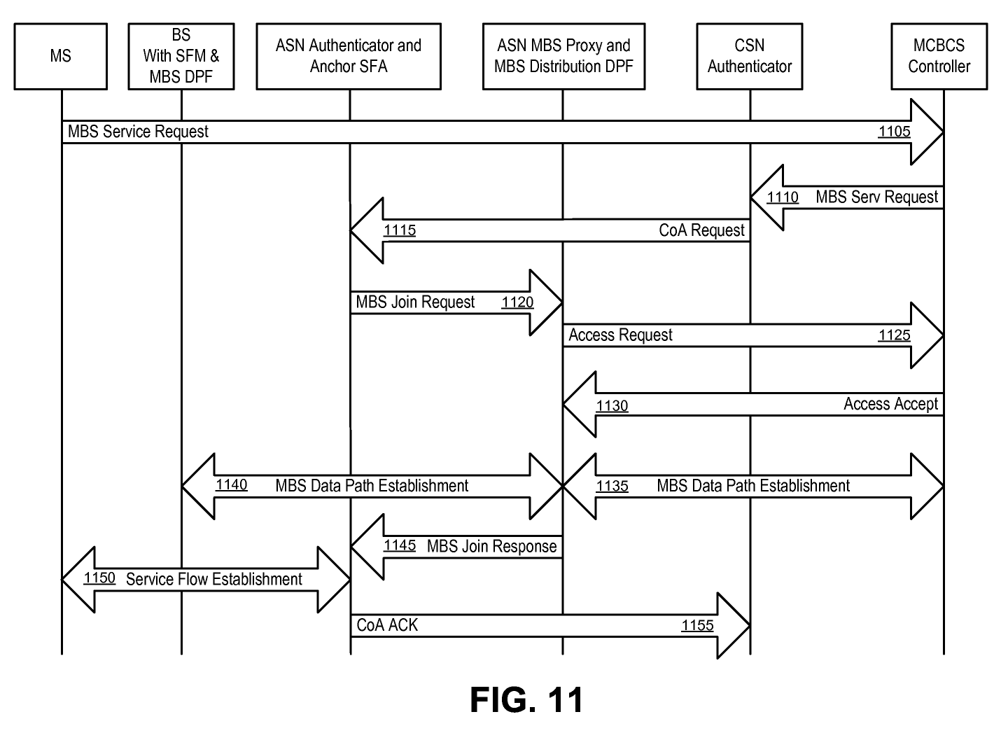

FIG. 11 shows an example of a multicast-broadcast service initialization procedure via a mobile station service request. A MS can dynamically trigger MCBCS service system initialization via a service request with a MCBCS controller (1105). For example, a dynamic MS service subscription with a MCBCS controller can trigger one or more MCBCS service initialization procedures. In another example, a dynamic MS service registration with a MCBCS Controller can trigger one or more MCBCS service initialization procedures.

A MCBCS controller can send a MBS service request to a CSN authenticator such as a HAAA or a policy server (1110). A MBS service request can include a Change of Authorization Request (CoA-Request). A CSN authenticator can receive a MBS service request from the MCBCS controller and can validate the MS's access authorization request to access the MBS via the anchor ASN. If authorized, an CSN authenticator can send an anchor ASN a message to allow access to a MBS service (1115). In some implementations, the message can include an access profile for a MS. In some implementations, a CSN authenticator can send a CoA-Request to an anchor SFA in the anchor ASN.

An anchor SFA can determine an address of a MCBCS proxy based on information received from a CSN authenticator. The anchor SFA can send a MBS join request to a MCBCS proxy (1120). In some implementations, an anchor SFA can identify the appropriate MCBCS proxy corresponding to a MCBCS controller which can be specified in an access profile of a MS. In some implementations, an anchor SFA can determine whether a MCBCS proxy and MCBCS controller service association exists by accessing configuration information, e.g., performing a local ASN database lookup.

A MCBCS proxy can initiate a service association with a MCBCS controller corresponding with a requested MBS service. In some implementations, a MCBCS proxy can send an access request to a MCBCS Controller based on receiving a join request from an anchor SFA (1125). Such an access request can include an IP address associated with the MCBCS proxy. Once the service association is stablished between the MCBCS Proxy and the MCBCS controller, the MCBCS Controller can respond with an access accept and can push down service parameters associated with a specific MCBCS program to the MCBCS proxy (1130). Service parameters can include one or more of MCBC service policy information, MCBCS transmission zone, and a PDF identifier. In some implementations, service parameters can include one or more of IP multicast address for a MCBCS service distribution tree, program ID, QoS parameters, and accounting type.

An anchor ASN can receive a service profile for a specific MCBCS program from a given MCBCS Controller. A MCBCS proxy, in the achnor ASN, can use the service parameters that are provided by the MCBCS Controller to trigger the service infrastructure establishment with a corresponding MBS DPF. Service infrastructure establishment can include establishing a MBS data path between a MCBCS Controller and a MBS proxy (1135). Service infrastructure establishment can include establishing a MBS data path between a MBS Proxy and a MBS DPF in a base station (1140).

In some implementations, a MBS proxy can send a join response to the anchor SFA to notify the anchor SFA about the establishment of the MBS data path (1145). The anchor SFA can establish a MBS service flow with a MS based on receiving a MBS join response (1150). The anchor SFA can send a CoA Acknowledgement (CoA ACK) to the CSN authenticator to signal completion of server flow establishment (1155).

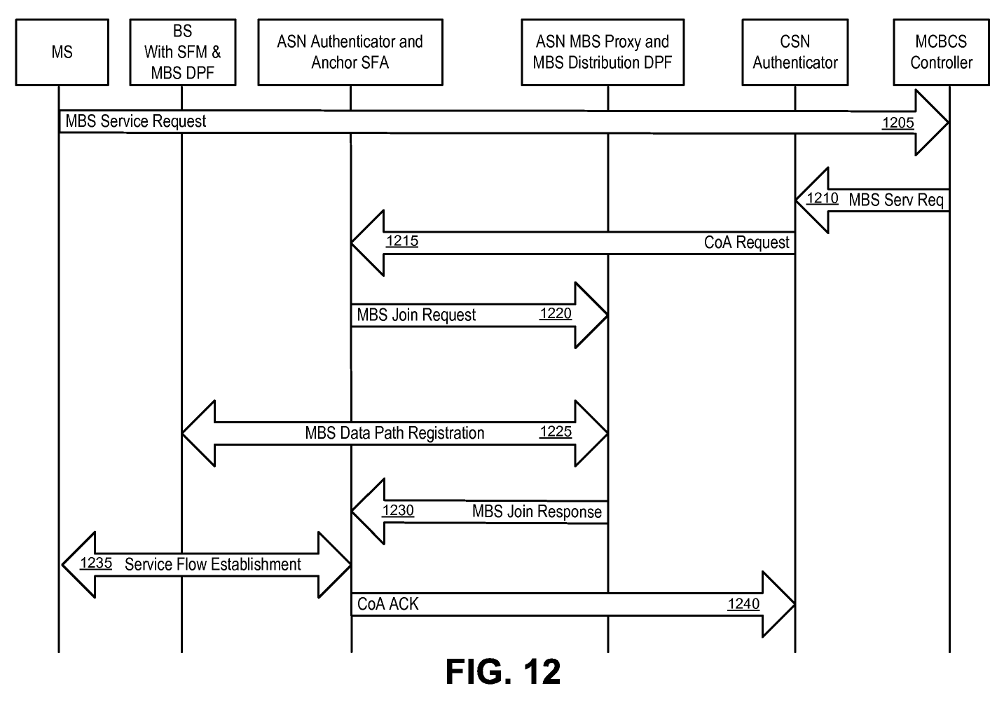

FIG. 12 shows an example of a multicast-broadcast service initialization procedure, via a mobile station service request, that uses data path registration. In this example, bearer infrastructure already exists. A MS can dynamically trigger MCBCS service system initialization via a service request sent to a MCBCS controller (1205). A MCBCS controller can send a MBS service request to a CSN authenticator such as a HAAA or a policy server (1210). A MBS service request can include a Change of Authorization Request (CoA-Request). If authorized, the CSN authenticator can send an anchor ASN a message to allow access to the MBS service (1215). In some implementations, a CSN authenticator can send a CoA-Request to an anchor SFA in the anchor ASN. The Anchor SFA can select a MBS proxy and can send a MBS join request to the selected MBS proxy (1220).

The MBS proxy can communicate with a MBS DPF in a BS serving the MS. In some implementations, the MBS proxy can perform MBS data path registration with a MBS DPF (1225). The MBS proxy can send a MBS join response to the Anchor SFA to signal a successful data path registration (1230). The anchor SFA and MS can establish a MBS service flow (1235). The anchor SFA can send a CoA ACK to the CSN authenticator to signal completion of service flow establishment (1240).

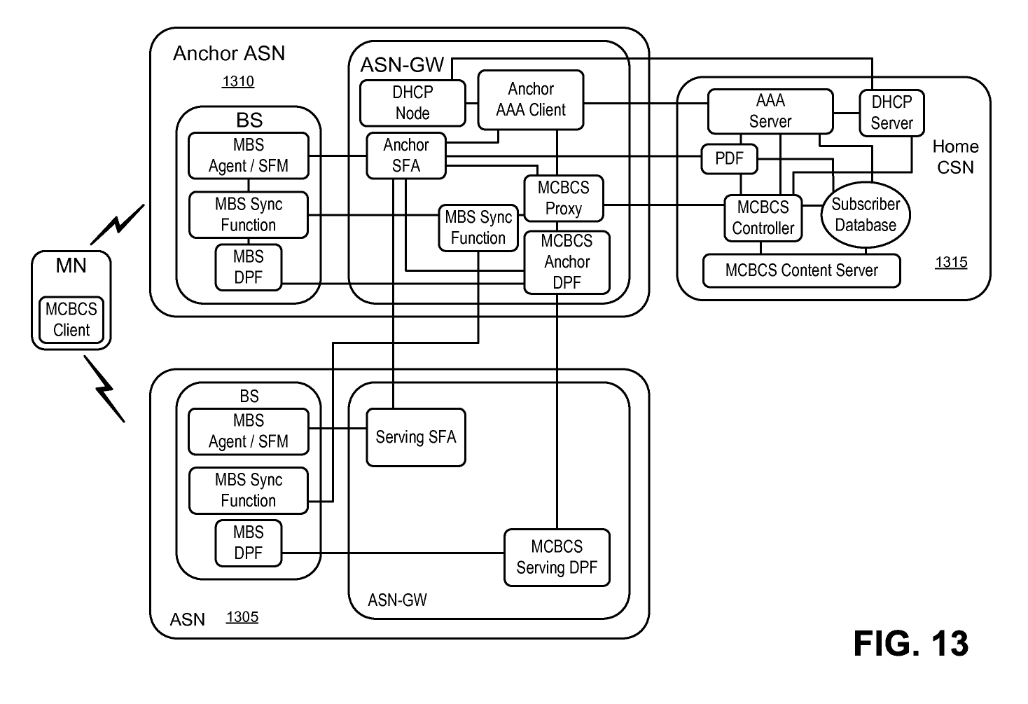

FIG. 13 shows a different wireless communication system architecture. A serving ASN 1305, serving a MS, can use one or more entities to communicate with an anchor ASN 1310 associated with the MS to reach a CSN 1315 associated with the MS. In some implementations, a serving ASN 1305 can use a serving SFA to communicate with an anchor SFA. In some implementations, a serving ASN 1305 can use a MCBCS serving DPF to reach a MCBCS anchor DPF.

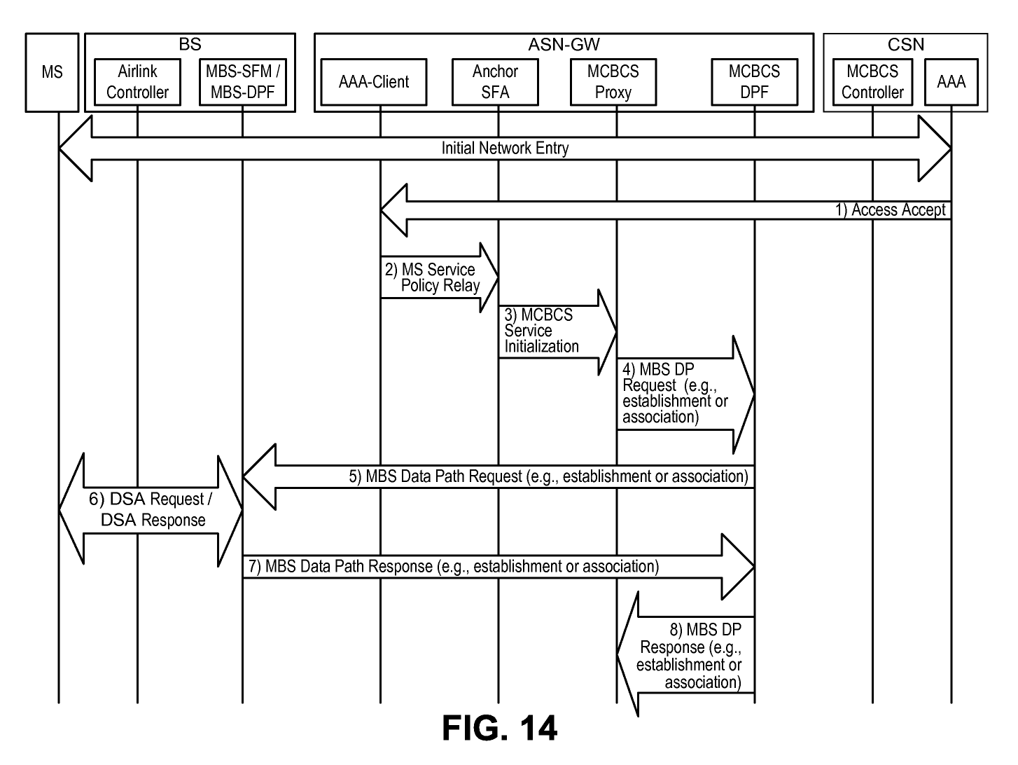

FIG. 14 shows another example of a multicast-broadcast service initialization procedure based on initial network entry. In some implementations, an initial network entry can trigger a CSN AAA to communicate with a ASN AAA to initialize MBS services for a MBS pre-provisioned MS.

In some implementations, a MBS Data Path Establishment request for a given MCBCS content distribution can trigger an airlink MBS Multicast Transport Connection Establishment (e.g., MBS Service Flow Establishment). In some implementations, a MBS Data Path association request for a given MCBCS content can trigger an airlink MBS Multicast Transport Connection Establishment (e.g., MBS Service Flow Establishment). In some implementations, a BS can exchange dynamic service addition (DSA) messages, e.g., DSA-REQ and DSA-RSP messages in accordance with IEEE 802.16, with the MS who triggers the current MBS service initialization operation if the given MBS service is for the broadcast service.

In some implementations, a MCBCS proxy can send a MBS Data path Registration or Association Request to a serving BS to trigger an airlink MBS Multicast Transport Connection Establishment via DSA messages such as DSA-REQ and DSA-RSP to the MS that has pre-subscribed to a MBS service. Once the airlink multicast service flow is established, the MBS DPF at the serving BS can respond to an anchor MCBCS DPF with a MBS Data Path Registration Response.

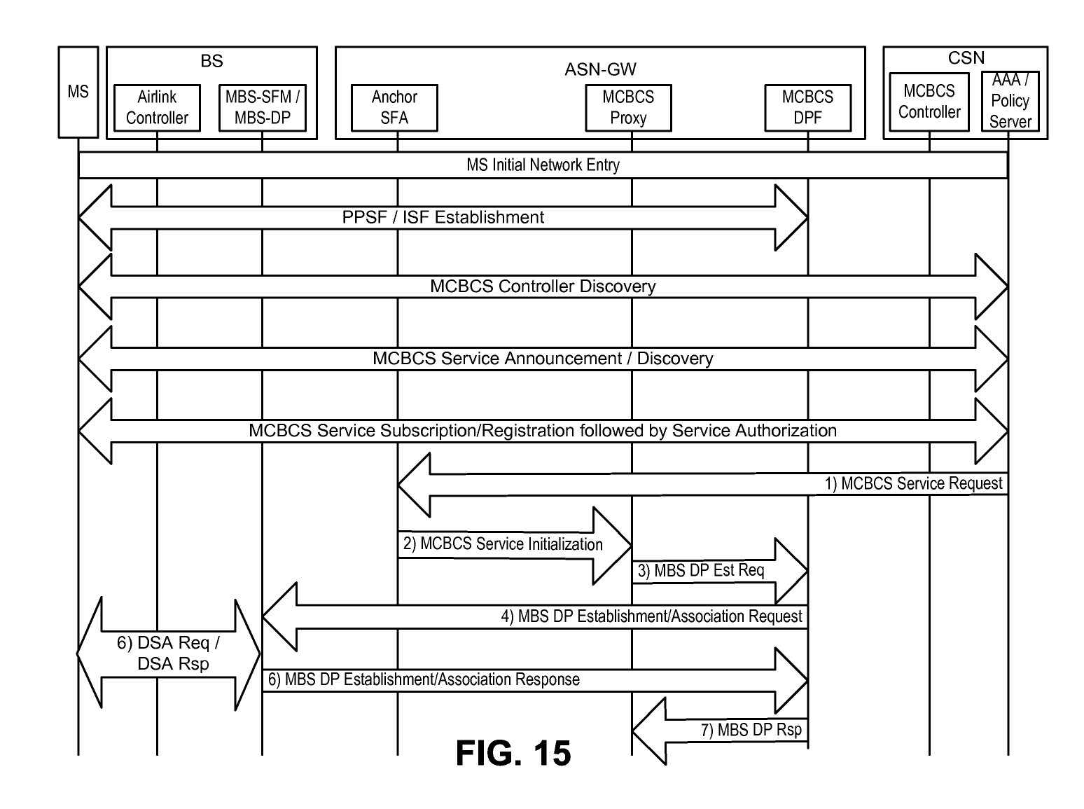

FIG. 15 shows another example of a multicast-broadcast service initialization procedure via a mobile station service request. In some implementations, a MS sends a MBS service request to a MCBCS controller after initial network entry to receive a data feed associated with a MBS program.

In some implementations, a MBS data path establishment for MCBCS content distribution can trigger a MBS service flow establishment. For example, a MBS data path establishment or association request can trigger an airlink MBS Multicast Transport Connection Establishment DSA-REQ and DSA-RSP messages to the MS that triggers the current MBS service initialization operation if the given MBS service is for the broadcast service. If the airlink MBS Multicast Transport Establishment via DSA-REQ and DSA-RSP was triggered, the MBS Multicast Data Path Establishment Response can be sent by a target MBS DPF of the serving BS after the confirmation of the airlink MBS Multicast Transport Establishment is completed. In some implementations, the MBS Data Path Establishment Response can be sent by a target MBS DPF of the serving BS once the serving BS completes the multicast transport establishment request.

In some implementations, a MBS Data Path Registration or Association procedure can trigger the airlink MBS Multicast Transport Connection Establishment. For example, a BS can exchange DSA-REQ and DSA-RSP messages with the MS requesting a MBS service. The serving BS can respond to the anchor MBS DPF with a MBS DSA-RSP Registration Response.

In some implementations, an airlink connectivity establishment can be triggered as the MS triggers the service establishment. For dynamic MCBCS service requests, an airlink multicast connection establishment can be triggered after the MS service subscription or registration for a given MCBCS programming and during the multicast or broadcast data path establishment or association with a requesting MS.

The disclosed and other embodiments and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for wireless communications, comprising:
receiving an access profile associated with a wireless device from a connectivity service network which is operable to determine whether the wireless device has privilege to a data feed provided by a multicast-broadcast service controller;
operating a proxy, which is in communication with the multicast-broadcast service controller, based on the access profile to obtain service parameter information associated with the data feed and to use a first multicast-broadcast service data path between the proxy and the multicast-broadcast service controller to receive the data feed; and
operating a base station to deliver the data feed to the wireless device in accordance with the service parameter information, the base station operable to use a second, different multicast-broadcast service data path between the proxy and the base station to receive the data feed.

2. The method as in claim 1, further comprising:
causing an authentication server in the connectivity service network to send the access profile in response to an initial network entry of the wireless device, wherein the wireless device is associated with the data feed before the initial network entry.

3. The method as in claim 1, further comprising:
operating the multicast-broadcast service controller to send a message to an authentication server in the connectivity service network in response to a multicast-broadcast service request from the wireless device; and
using the authentication server to send the access profile in response to the message from the multicast-broadcast service controller.

4. The method as in claim 1, further comprising:
selectively instantiating the first multicast-broadcast service data path between the proxy and the multicast-broadcast service controller based on whether a prior instantiation of the first multicast-broadcast service data path exists.

5. The method as in claim 4, further comprising:
communicating with a second wireless device that has access to the data feed; and
using the first multicast-broadcast service data path to provide the data feed to the second wireless device.

6. The method as in claim 1, further comprising:
selectively instantiating the second multicast-broadcast service data path between the proxy and the base station based on whether a prior instantiation of the second multicast-broadcast service data path exists.

7. The method as in claim 6, further comprising:
communicating with a second wireless device that has access to the data feed; and
associating the second wireless device with the second multicast-broadcast service data path,
wherein operating the base station comprises operating the base station to deliver the data feed to multiple wireless devices in accordance with the service parameter information.

8. The method as in claim 1, further comprising:
operating an access service network to provide wireless service to wireless devices based on an orthogonal frequency-division multiplexing air interface, wherein the access service network includes the proxy.

9. The method as in claim 1, wherein operating the proxy comprises operating a multicast-broadcast service distribution function to forward data between the first and second multicast-broadcast service data paths.

10. The method as in claim 1, wherein the access profile comprises address information associated with the multicast-broadcast service controller.

11. The method as in claim 1, wherein the service parameter information comprises one or more quality-of-service parameters and multicast-broadcast service transmission zone information.

12. A method for wireless communications, comprising:
operating an anchor access serving network (ASN) to process Multicast Broadcast Service (MCBCS) information obtained from an initial reception of a mobile station's service profile from a respective authentication, authorization and accounting (AAA) server or from a respective policy server to identify one or more serving MCBCS controllers associated with the mobile station; and
initializing MCBCS service with an identified MCBCS Controller after an MCBCS Controller service announcement to the mobile station or a mobile station service discovery from the identified MCBCS Controller.

13. The method as in claim 12, comprising:
operating an anchor Service Flow Authorization (SFA) agent associated with the mobile station to look for a responsible MCBCS Proxy at the anchor ASN to cause triggering of a peer-to-peer service association establishment between the MCBCS Proxy and a corresponding MCBCS Controller when there is no serving MCBCS Controllers for the mobile station.

14. An access service network for wireless communications, comprising:
means for receiving an access profile associated with a wireless device from a connectivity service network which determines whether the wireless device has privilege to a data feed provided by a multicast-broadcast service controller;
a proxy mechanism that is in communications with the multicast-broadcast service controller based on the access profile, the proxy mechanism operable to obtain service parameter information associated with the data feed and to use a first multicast-broadcast service data path between the proxy mechanism and the multicast-broadcast service controller to receive the data feed; and
means for operating a base station to deliver the data feed to the wireless device in accordance with the service parameter information, the base station operable to use a second, different multicast-broadcast service data path between the proxy mechanism and the base station to receive the data feed to receive the data feed.

15. The network as in claim 14, further comprising:
means for causing an authentication server in the connectivity service network to send the access profile in response to an initial network entry of the wireless device, wherein the wireless device is associated with the data feed before the initial network entry.

16. The network as in claim 14, wherein the multicast-broadcast service controller is operable to send a message to an authentication server in the connectivity service network in response to a multicast-broadcast service request from the wireless device, wherein the authentication server is operable to send the access profile in response to the message from the multicast-broadcast service controller.

17. The network as in claim 14, further comprising:
means for selectively instantiating the first multicast-broadcast service data path between the proxy mechanism and the multicast-broadcast service controller based on whether a prior instantiation of the first multicast-broadcast service data path exists.

18. The network as in claim 17, further comprising:
means for communicating with a second wireless device that has access to the data feed; and
means for using the first multicast-broadcast service data path to provide the data feed to the second wireless device.

19. The network as in claim 14, further comprising:
means for selectively instantiating the second multicast-broadcast service data path between the proxy mechanism and the base station based on whether a prior instantiation of the second multicast-broadcast service data path exists.

20. The network as in claim 19, further comprising:
means for communicating with a second wireless device that has access to the data feed; and
means for associating the second wireless device with the second multicast-broadcast service data path,
wherein the means for operating the base station comprises means for operating the base station to deliver the data feed to multiple wireless devices in accordance with the service parameter information.

21. The network as in claim 14, further comprising:
means for operating an access service network to provide wireless service to wireless devices based on an orthogonal frequency-division multiplexing air interface, wherein the access service network includes the proxy mechanism.

22. The network as in claim 14, wherein the proxy mechanism comprises means for operating a multicast-broadcast service distribution function to forward data between the first and second multicast-broadcast service data paths.

23. The network as in claim 14, wherein the access profile comprises address information associated with the multicast-broadcast service controller.

24. The network as in claim 14, wherein the service parameter information comprises one or more quality-of-service parameters and multicast-broadcast service transmission zone information.

25. A wireless communication system, comprising:
a multicast-broadcast service controller operable to provide a data feed associated with a multicast-broadcast service;
a connectivity service network which determines whether wireless devices have a privilege to access the data feed; and
an access service network, in communication with the connectivity service network and the multicast-broadcast service controller, comprising:
a mechanism configured to distribute an access profile associated with a wireless device, wherein the mechanism is operable to receive the access profile from the connectivity service network;
a proxy mechanism configured to communicate with the multicast-broadcast service controller based on the access profile, the proxy mechanism operable to obtain service parameter information associated with the data feed and to use a first multicast-broadcast service data path between the proxy mechanism and the multicast-broadcast service controller to receive the data feed; and
a base station operable to deliver the data feed to the wireless device in accordance with the service parameter information, the base station operable to use a second, different multicast-broadcast service data path between the proxy mechanism and the base station to receive the data feed.

26. The system as in claim 25, wherein the connectivity service network comprises:
an authentication server operable to send the access profile in response to an initial network entry of the wireless device, wherein the wireless device is associated with the data feed before the initial network entry.

27. The system as in claim 25, wherein the connectivity service network comprises an authentication server operable to send the access profile in response to a request message,
wherein the multicast-broadcast service controller is operable to send the request message to the authentication server in response to a multicast-broadcast service request from the wireless device.

28. The system as in claim 25, wherein the access service network comprises a mechanism to selectively instantiate the first multicast-broadcast service data path between the proxy mechanism and the multicast-broadcast service controller based on whether a prior instantiation of the first multicast-broadcast service data path exists.

29. The system as in claim 28, wherein the access service network is operable to communicate with a second wireless device that has access to the data feed and use the first multicast-broadcast service data path to provide the data feed to the second wireless device.

30. The system as in claim 25, wherein the access service network comprises a mechanism to selectively instantiate the second multicast-broadcast service data path between the proxy mechanism and the base station based on whether a prior instantiation of the second multicast-broadcast service data path exists.

31. The system as in claim 30, wherein the access service network is operable to communicate with a second wireless device that has access to the data feed and to associate the second wireless device with the second multicast-broadcast service data path,
wherein the base station is operable to deliver the data feed to multiple wireless devices in accordance with the service parameter information.

32. The system as in claim 25, wherein the base station is configured to provide wireless communications to wireless devices based on an orthogonal frequency-division multiplexing air interface.

33. The system as in claim 25, wherein the proxy mechanism is operable to use a multicast-broadcast service distribution function to forward data between the first and second multicast-broadcast service data paths.

34. The system as in claim 25, wherein the access profile comprises address information associated with the multicast-broadcast service controller.

35. The system as in claim 25, wherein the service parameter information comprises one or more quality-of-service parameters and multicast-broadcast service transmission zone information.
